(19) United States
(12) Patent Application Publication
(10) Pub. No.: US 2025/0347155 A1
(43) Pub. Date: Nov. 13, 2025

(54) CLOSURE LATCH ASSEMBLY EQUIPPED WITH A DOUBLE PAWL LATCH MECHANISM WITH DEDICATED SECONDARY PAWL FOR SECONDARY POSITION

(71) Applicant: MAGNA CLOSURES INC., Newmarket (CA)

(72) Inventors: Francesco CUMBO, Newmarket (CA); Dunia SARDELLI, Newmarket (CA)

(21) Appl. No.: 19/196,359

(22) Filed: May 1, 2025

Related U.S. Application Data
(60) Provisional application No. 63/643,945, filed on May 8, 2024.

(51) Int. Cl. E05B 77/04; E05B 81/16

(52) U.S. Cl. CPC E05B 77/04; E05B 81/16

(57) ABSTRACT

A closure latch assembly for a closure member of a motor vehicle, including a latch mechanism including a ratchet, a double pawl mechanism having a primary pawl for holding the ratchet in a primary latched position, and a secondary pawl for holding the ratchet in a secondary latch position, wherein the primary pawl is configured to abut the secondary pawl during a crash condition to prevent the ratchet to move to its striker release position.

### CROSS-REFERENCE TO RELATED APPLICATIONS

This application claims the benefit of U.S. Provisional Application Ser. No. 63/643,945, filed May 8, 2024, which is incorporated herein by reference in its entirety.

### FIELD

The present disclosure relates generally to closure latches for a vehicle passenger door. More particularly, the present disclosure is directed to a closure latch equipped with a double pawl, single ratchet latch mechanism.

### BACKGROUND

This section provides background information related to closure latches and is not necessarily prior art to the closure latch of the present disclosure.

Many modern closure latches for closure panels of motor vehicles provide various features to maintain the closure latch in various states, such as a fully closed state, partially closed state, and fully open state. It is known to utilize two pawls to maintain a ratchet of the closure latch in a primary striker capture position, corresponding to the fully closed state, and a secondary striker capture position, corresponding to the partially closed state, with one pawl, a primary pawl, engaging the ratchet while in the primary striker capture position, and another pawl, a secondary pawl, engaging the ratchet while in the secondary striker capture position. Such double pawl arrangements are well suited for releasably holding the ratchet in the primary and secondary striker capture positions, as well as improving release efforts during normal release operation. During crash conditions, it is desirable to ensure that the ratchet is continued to be held by the primary pawl in the primary capture position. As such, improvements are continually sought to advance the art of closure latches.

### SUMMARY

This section provides a general summary of the disclosure and is not intended to be considered as a comprehensive and exhaustive listing of its full scope or all of its aspects, features and objectives.

It is an aspect of the present disclosure to provide a closure latch assembly for a vehicle closure panel, with the closure latch assembly having a double pawl mechanism that overcomes at least the above drawbacks of known double pawl mechanisms.

It is a further aspect of the present disclosure to provide a closure latch assembly for a vehicle closure panel, with the closure latch assembly having a double pawl mechanism that allows a single one of the two pawls, separately from one another, to releasably maintain a ratchet in a primary striker capture position and a secondary striker capture position, respectively.

It is a further aspect of the present disclosure to provide a closure latch assembly for a vehicle closure panel, with the closure latch assembly having a double pawl mechanism that holds the ratchet in a primary striker capture position, and having a separate dedicated single pawl to hold the ratchet in a secondary striker capture position.

It is a further aspect of the present disclosure to provide a closure latch assembly for a vehicle closure panel, with the closure latch assembly having a double pawl mechanism that holds the ratchet in a primary striker capture position, and having a separate dedicated pawl to backstop a movement of the primary pawl during crash condition, or deformation of the primary pawl to hold the ratchet in its primary striker capture position, or substantially in its primary striker position.

It is a further aspect of the present disclosure to provide a closure latch assembly for a vehicle closure panel, with the closure latch assembly having a double pawl mechanism that holds the ratchet in a primary striker capture position, and having a separate dedicated pawl backstop a movement of the primary pawl during crash condition, or deformation of the primary pawl.

It is a further aspect of the present disclosure to provide a closure latch assembly for a vehicle closure panel, with the closure latch assembly having a double pawl mechanism having a primary pawl supported only by a primary pivot post for supporting the loads of the ratchet acting on the pawl during a normal condition of the latch, and having the primary pawl supported by both the primary pivot post and a secondary pivot post of a secondary pawl during a crash condition.

It is a further aspect of the present disclosure to provide a closure latch assembly for a vehicle closure panel, with the closure latch assembly having a double pawl mechanism that has a primary pawl surface for engaging a single ratchet notch surface when the ratchet is in a primary striker holding position, and a secondary pawl that has a secondary pawl surface for engaging the single ratchet notch surface when the ratchet is in a secondary striker capture position, wherein the secondary pawl surface is disengaged and aligned with the primary pawl when the double pawl mechanism is holding the ratchet in the primary striker capture position.

It is a further aspect of the present disclosure to provide a closure latch assembly for a vehicle closure panel, with the closure latch assembly having a double pawl mechanism that has a primary pawl with a primary pawl surface for engaging a single ratchet notch surface when the ratchet is in a primary striker holding position, and a secondary pawl that has a secondary pawl surface for engaging the single ratchet notch surface when the ratchet is in a secondary striker capture position, wherein the secondary pawl surface is further configured to engage the primary pawl when the double pawl mechanism is holding the ratchet in a striker capture position during a crash state of the latch.

A further aspect includes a closure latch assembly for a closure member of a motor vehicle, having a latch mechanism including a ratchet, a primary pawl and an auxiliary pawl and a secondary pawl, the ratchet being moveable between a primary striker capture position, a secondary striker capture position, and a striker release position, the primary pawl being moveable between a primary ratchet holding position, whereat the primary pawl holds the ratchet in its primary striker capture position and the auxiliary pawl holds the primary pawl in its primary ratchet holding positon and a ratchet releasing position, whereat the primary pawl permits the ratchet to move to its striker release position; and the secondary pawl being moveable between a secondary ratchet holding position, whereat the secondary pawl holds the ratchet in its secondary striker capture position and a ratchet releasing position, whereat the secondary pawl permits the ratchet to move to its striker release position; wherein the primary pawl is configured to abut the secondary pawl during a crash condition to prevent the ratchet from moving to its striker release position.

A further aspect includes a closure latch assembly for closure member of a motor vehicle, having a latch mechanism including a ratchet, a primary pawl, and a secondary pawl, the ratchet being moveable between a primary striker capture position, a secondary striker capture position, and a striker release position. The primary pawl being moveable between a primary ratchet holding position, whereat the primary pawl holds the ratchet in its primary striker capture position, and a primary ratchet releasing position, whereat the primary pawl permits the ratchet to move to its striker release position. The secondary pawl being moveable between a secondary ratchet holding position, whereat the secondary pawl holds the ratchet in its secondary striker capture position, and a secondary ratchet releasing position, whereat the secondary pawl permits the ratchet to move to its striker release position, wherein the primary pawl is configured to abut the secondary pawl during a crash condition to prevent the ratchet from moving to its striker release position.

In a further related aspect, during a non-crash condition of the closure latch assembly, the secondary pawl and the primary pawl are aligned and separated from one another by a gap.

In another related aspect, the ratchet comprises a single notch for engagement of both the primary pawl and the secondary pawl.

A further aspect includes a closure latch assembly for a closure member of a motor vehicle, having a latch mechanism including a ratchet, a primary pawl, an auxiliary pawl, and a secondary pawl. The ratchet being moveable between a primary striker capture position, a secondary striker capture position, and a striker release position. The primary pawl being moveable between a primary ratchet holding position, whereat the primary pawl holds the ratchet in its primary striker capture position, and a primary ratchet releasing position, whereat the primary pawl permits the ratchet to move to its striker release position. The auxiliary pawl being moveable between a primary pawl blocking position, whereat auxiliary pawl prevents rotation of the primary pawl from its primary ratchet holding position, and a primary pawl releasing position, whereat auxiliary pawl allows the primary pawl to rotate away from the ratchet to its ratchet releasing position under a bias imparted on the primary pawl by a primary pawl biasing member. The secondary pawl being moveable between a secondary ratchet holding position, whereat the secondary pawl holds the ratchet in its secondary striker capture position, and a secondary ratchet releasing position, whereat the secondary pawl permits the ratchet to move to its striker release position. The primary pawl and the secondary pawl are spaced from one another by a gap while the primary pawl is in the primary ratchet holding position.

Further areas of applicability will become apparent from the description provided herein. As noted, the description and any specific examples in this summary are intended for purposes of illustration only and are not intended to limit the scope of the present disclosure.

### BRIEF DESCRIPTION OF THE DRAWINGS

The drawings described herein have been provided to illustrate selected embodiments and specific features thereof and are not intended to limit the scope of the present disclosure. The present disclosure will now be described by way of example only with reference to the attached drawings, in which:

FIG. 1 is a perspective view of a motor vehicle having vehicle door equipped with a closure latch assembly constructed in accordance with the disclosure;

FIG. 2 is a side view of a latch mechanism of the closure latch assembly with a ratchet of the latch mechanism shown in a fully open, striker release position;

FIG. 3 is a side view of a latch mechanism of the closure latch assembly with the ratchet of the latch mechanism shown in a secondary closed, striker capture position in a normal state of the latch assembly;

FIG. 4 is a side view of the latch mechanism of the closure latch assembly with the ratchet shown in a primary striker capture position in a normal state of the latch assembly; and

FIG. 5 is a side view of the latch mechanism of the closure latch assembly with the ratchet shown in or near the primary striker capture position and with the primary pawl in engagement with the secondary pawl.

### DETAILED DESCRIPTION OF EXAMPLE EMBODIMENTS

Example embodiments of a closure latch assembly for use in motor vehicle door closure systems are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

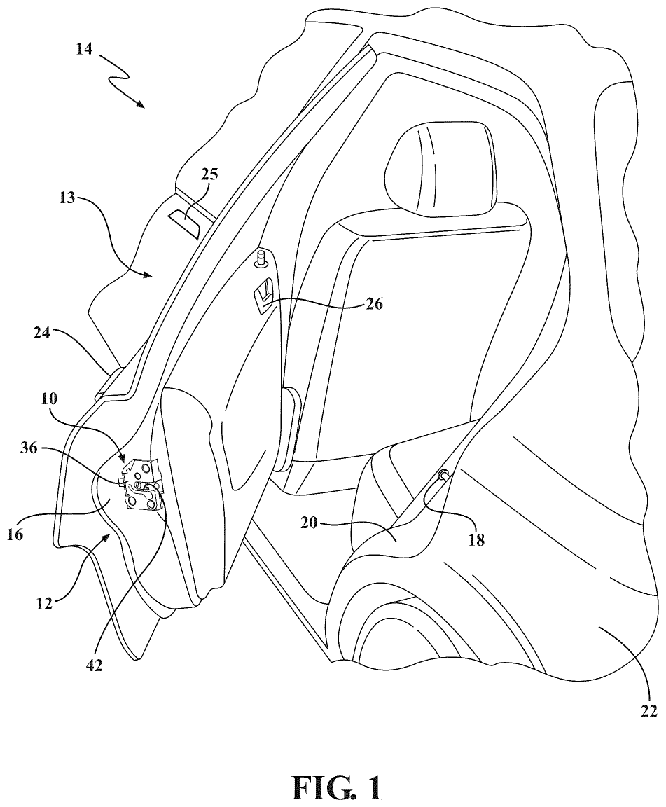

Referring initially to FIG. 1, a closure latch assembly, also referred to as closure latch or latch assembly 10, for a closure member, also referred to as closure panel, such as a swing door, shown as a rear door 12, by way of example and without limitation, of a motor vehicle 14 is shown positioned along a shut face portion 16 of door 12 and is configured to releasably engage and capture a striker 18 secured to a vehicle body 22 to extend within a door opening 20 formed in vehicle body 22 in response to movement of door 12 from an open position to a closed position. Door 12 is shown to include an outside door handle 24 and an inside door handle 26, both of which are operatively connected (i.e., electrically and/or mechanically) to closure latch assembly 10. While not shown, it is understood that a similar closure latch assembly is provided in association with a front door 13 of vehicle 14 shown to include its own outside door handle 25.

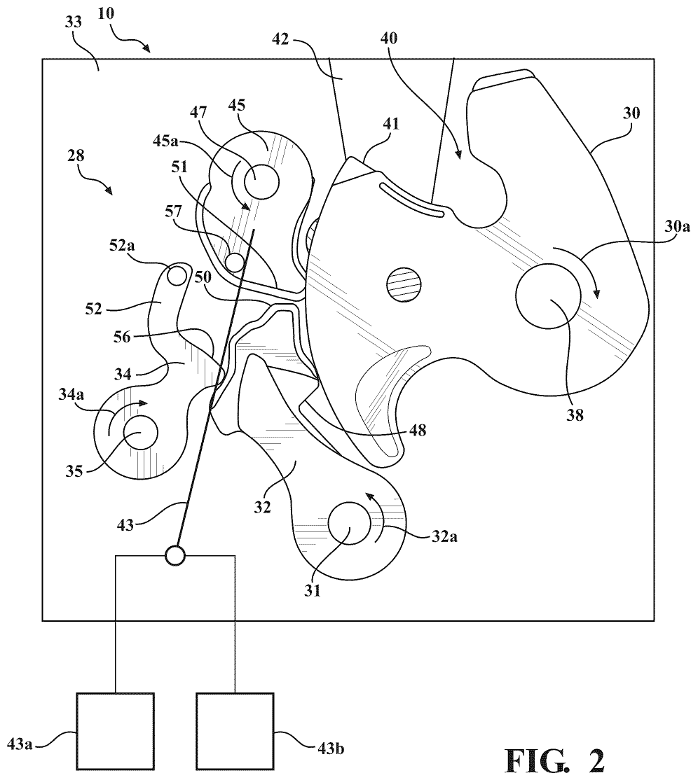

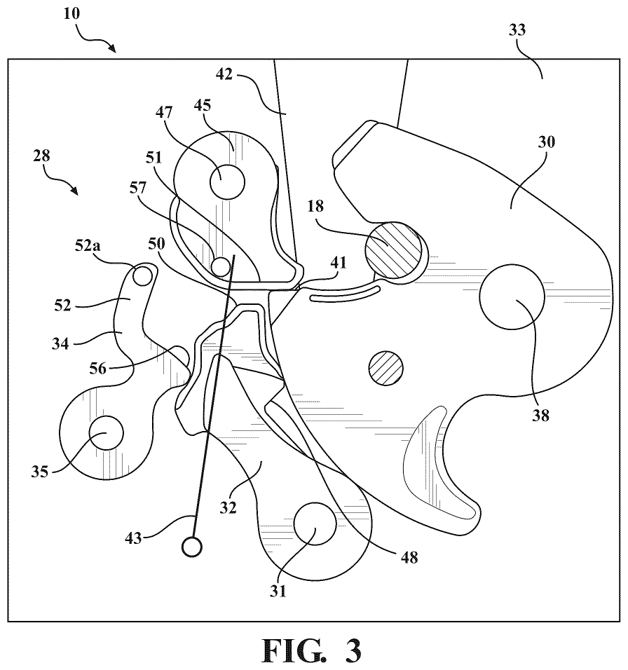

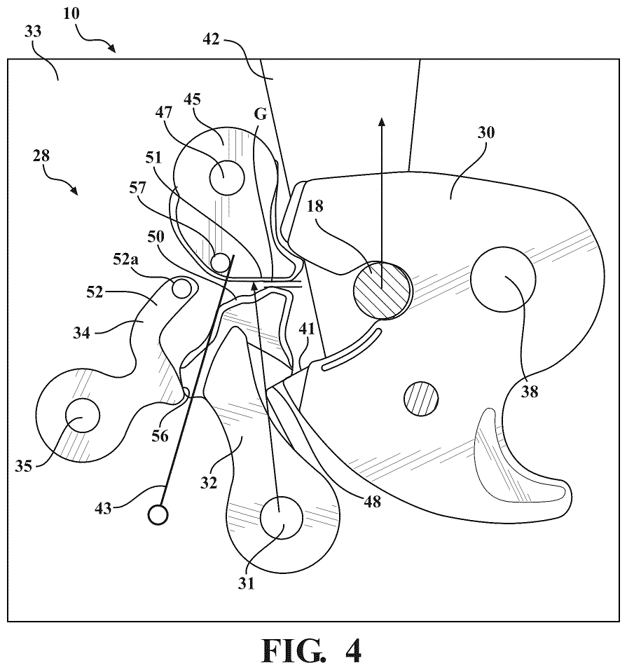

Referring now to FIGS. 2-5, a non-limiting example embodiment of internal components of closure latch assembly 10, including a latch mechanism 28, thereof is shown, with latch mechanism 28 of closure latch assembly 10 in a normal or non-crash state of the latch 10 shown in a fully released, open position in FIG. 2, and in a fully closed, primary latched position in FIG. 4, and in a secondary latched position in FIG. 3.

Latch mechanism 28 is shown having a ratchet 30, a primary pawl 32 pivotally mounted to the frame plate 33 by a primary pawl pivot post, also referred to as primary pawl pin 31, and an auxiliary (blocking) pawl 34 pivotally mounted to the frame plate 33 by an auxiliary pawl pivot post 35, also referred to as auxiliary pawl 34. Primary pawl 32 may be illustratively biased by a primary pawl biasing member, such as a spring 32a, and also referred to as primary pawl biasing spring, in counterclockwise sense, as viewed in FIG. 2, away from the ratchet 30, while auxiliary pawl 34 may be biased in a clockwise sense by an auxiliary pawl biasing member, such as a spring 34a, and also referred to as auxiliary pawl biasing spring, as viewed in FIG. 2, towards the primary pawl 32 into a primary pawl blocking position to prevent counterclockwise rotation of the primary pawl 32 away from the ratchet 30 while primary pawl 32 is in its primary ratchet holding position.

Ratchet 30 is pivotably mounted to frame plate, also referred to the plate segment 33, of a latch housing 36 (FIG. 1) via a ratchet pin 38 for pivotal movement about a ratchet pin axis. Ratchet 30 has a ratchet slot, also referred to as striker slot 40, alignable with a fishmouth slot 42 formed in latch housing 36. Ratchet 30 is moveable between a primary closed or “primary striker capture” position (FIG. 4) whereat striker 18 is held within fishmouth slot 42 via being captured in striker slot 40; a secondary striker capture position (FIG. 3), whereat striker 18 is held within fishmouth slot 42 via being captured in striker slot 40 to hold closure member 12 in a partially open, also referred to as partially closed position or secondary closed position; and an open or “striker release” position (FIG. 2) whereat striker 18 is free to be released from striker slot 40 and fishmouth slot 42, thereby allowing closure member 12 to be moved to an open position. Ratchet 30 is biased by a ratchet biasing member, also referred to as primary ratchet spring or ratchet spring 30a, toward its striker release position, corresponding to a clockwise direction as viewed in FIG. 2.

Primary pawl 32 is pivotably supported for movement by primary pawl pin 31 for pivotal movement about a pawl pivot axis between a secured, primary ratchet holding position, also referred to as ratchet holding position or “closed” position (FIG. 4), whereat primary pawl 32 locates and holds ratchet 30 in its primary striker capture position by engaging a single ratchet capture surface, also referred to as single ratchet notch 41; and ratchet releasing position (FIG. 3), whereat primary pawl 32 is located away from the ratchet 30 and to allow the ratchet 30 to rotate clockwise under the bias imparted by the ratchet spring 30a toward the striker release position, and whereupon a secondary pawl 45, pivotably supported for movement by a secondary pawl pivot post, also referred to as secondary pawl pin 47, about a secondary pawl pivot axis that is separate and displaced from the primary pawl pivot post 31, between a secondary ratchet holding position, whereat secondary pawl 45 locates and holds the ratchet 30 in its secondary striker capture position by engaging the single ratchet notch 41, and a secondary ratchet release position, also referred to as ratchet release position or “open” position (FIG. 2), whereat primary pawl 32 and secondary pawl 45 are positioned to permit ratchet 30 to move to its striker release position, such as under a bias imparted by ratchet spring 30a on ratchet 32 or a door seal load. Secondary pawl biasing member 45a is operable to normally bias secondary primary pawl 45 towards its ratchet engaging position, for example in a counterclockwise direction viewed in FIG. 2.

Auxiliary pawl 34 is pivotably supported for movement by auxiliary pawl pivot post, also referred to as auxiliary pawl pin 35 between a secured, closed, also referred to as primary pawl blocking position (FIG. 4), whereat auxiliary pawl 34 locates and holds (blocks) primary pawl 32 in its primary ratchet holding position, such that ratchet 30 is locked in its primary striker capture position, and a unblocking, primary pawl releasing position (FIG. 3), whereat auxiliary pawl 34 allows the primary pawl 32 to rotate away from the ratchet 30 to its primary ratchet releasing position under the bias imparted on the primary pawl 32 by the primary pawl biasing member 32a to disengage from the single ratchet notch 41 and allow the ratchet 30 to move away from the primary striker holding position of FIG. 4, such as under a bias imparted by ratchet spring 30a or door seal. Auxiliary pawl 34 has illustratively an actuation arm 52 arranged for engagement with a release lever 43 of a power actuatable mechanism 43a or manually actuatable release mechanism 43b. Actuation arm 52 is illustrated as having an auxiliary pawl lug 52a upstanding in laterally outward direction from actuation arm 52, in generally parallel relation with an axis of rotation of auxiliary pawl 34, to be engaged by the release lever 43 while releasing ratchet 30 from its primary striker capture position. Secondary pawl 45 is illustratively shown to have a separate secondary pawl lug 57 upstanding in laterally outward direction from secondary pawl 45, in generally parallel relation with an axis of rotation of secondary pawl 45, to be engaged by the release lever 43 while releasing ratchet 30 from its secondary striker capture position.

The primary pawl 32 has a primary ratchet holding surface, also referred to as primary holding projection 48 for engaging with the single ratchet notch 41, and a secondary surface, also referred to as secondary or auxiliary holding projection 50, illustratively on a position of the pawl 32 opposite that of the primary holding projection 48. The ratchet 30 is supported by the primary holding projection 48 while in the primary striker capture position and during a normal operation condition of the latch 10 (e.g. a non-impact, non-crash state/condition) and is supported by a secondary holding projection 51 provided on the secondary pawl 45 while the ratchet 30 is in the secondary striker capture position and during a normal operation condition of the latch 10 (e.g. a non-impact, non-crash state/condition). The primary holding projection 48 and the secondary holding projection 51 are configured to each engage and disengage the single ratchet notch 41 during respective primary and secondary ratchet holding states. The primary holding projection 48 and the secondary holding projection 51 can each be provided having a desired contour to facilitate a desired effort required for moving the primary pawl 32 between its primary ratchet holding and releasing positions with the ratchet 30 in the primary striker capture position, and the secondary pawl 45 between its secondary ratchet holding and releasing positions with the ratchet 30 in the secondary striker capture position. For example the primary pawl 32 surface (e.g surface 48) may be configured having an eccentric profile for positive backout, while the secondary pawl 45 surface (e.g. surface 51) may be configured for neutral or negative backout. A blocking surface 56 of the auxiliary pawl 34 is configured to engage, confront and block the primary pawl 32 while the ratchet 30 is in the primary striker capture position, thereby ensuring the ratchet 30 is desirably maintained in its primary striker capture position, when desired, and to move out of the blocking position with the primary pawl 32 to allow the primary pawl 32 to move away from the single ratchet notch 41 during an intended release operation via selective actuation of actuator, for example when release lever 43 is intentionally rotated counter clockwise to abut upstanding auxiliary pawl lug 52a, as shown in FIG. 2. Previously or simultaneously with movement of release lever 43, secondary pawl 45 is also controlled to move outwardly away from the ratchet 30 during a release operation so as not to be in alignment with the single ratchet notch 41 when the ratchet 30 is released from its primary striker capture position and is moving away towards the striker release position. For example initial movement of release lever 43 rotated counter-clockwise, as viewed in FIG. 2, may first abut secondary pawl lug 57 on the secondary pawl 45 to rotate the secondary pawl 45 clockwise and out of alignment with the single ratchet notch 41, and thereafter, release lever 43 continues rotation counter-clockwise, as viewed in FIG. 2, to abut auxiliary pawl lug 52a on the auxiliary pawl 52 to rotate the auxiliary pawl 52 counter-clockwise and out of blocking engagement from primary pawl 32. Alternatively, release lever 43 may be configured for conjoint rotation with the secondary pawl 45 and be co-axially mounted on secondary pawl pin 47.

Closure latch assembly 10 may include a power latch release mechanism or a manual release mechanism (both not shown) to operably open latch mechanism 28 between primary latched (FIG. 4), secondary latched (FIG. 3) and open positions (FIG. 2). For example, power latch release mechanism 43a or a manual release mechanism 43b may be adapted to move the release lever 43 to move primary pawl 32 and secondary pawl 45 from their respective ratchet holding positions to their ratchet releasing positions.

With reference to FIG. 4, when the latch is in a normal or non-crash state, auxiliary holding projection 50 and secondary holding projection 51 are aligned with one another, but spaced from each other as separated by a Gap G, such that auxiliary holding projection 50 and secondary holding projection 51 are not in engagement or contact with each other.

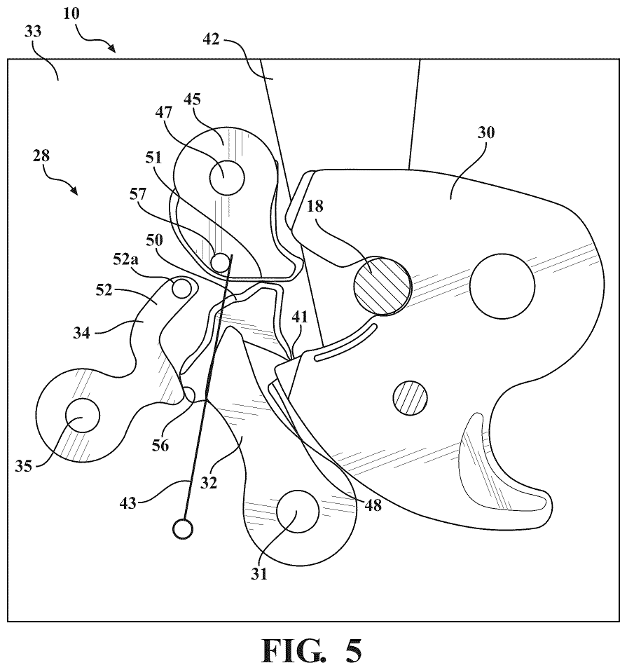

With additional reference to FIG. 5, during a crash condition of the latch 10, the crash forces tending to act on the striker 18 in the open direction indicated by arrow OD cause (via an angular rotation AR of the ratchet 30) the primary pawl 32 to deform, move or stretch to allow rotation of the ratchet 30 slightly away from the primary striker capture position shown in FIG. 4, while the primary pawl 32 remains in the ratchet holding position and the auxiliary pawl 34 is in the blocking position. As a result of the deformation, movement, or stretching of the primary pawl 32, holding projection 50 and secondary holding projection 51 enter into contact with one another as the gap G is closed, thereby resisting further deformation, movement, or stretching of the primary pawl 32. Before closing of the gap G, the crash loading on the primary pawl 32 is supported by the primary pawl pivot post 31, and not by the secondary pawl pin 47 as the single notch surface 41 is not in engagement with the secondary holding projection 51. After the closing of the gap G, the loading imparted to the primary pawl 32 and the primary pawl pivot post 33 from the ratchet 30 when the latch is in a crash condition is distributed to both the primary pawl pivot post 33 and the secondary pawl pin 47, thereby causing a reaction force in both the primary pawl pivot post 33 and the secondary pawl pin 47 and thus, increasing the holding force of the ratchet 30 in a position between the primary ratchet holding position and the secondary ratchet holding position, in comparison to the non-crash condition shown in FIG. 4 where only the primary pawl pivot post 33 supports the loading of the ratchet 30 via the primary pawl 32. As a result the rotation of the ratchet 30 away from the primary striker capture position is further hindered by both the primary pawl and the secondary pawl acting on the ratchet 30 to resist further rotation.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure latch assembly for a closure member of a motor vehicle, comprising:
a latch mechanism including a ratchet, a primary pawl, and a secondary pawl, the ratchet being moveable between a primary striker capture position, a secondary striker capture position, and a striker release position, the primary pawl being moveable between a primary ratchet holding position, whereat the primary pawl holds the ratchet in its primary striker capture position, and a primary ratchet releasing position, whereat the primary pawl permits the ratchet to move to its striker release position; and
the secondary pawl being moveable between a secondary ratchet holding position, whereat the secondary pawl holds the ratchet in its secondary striker capture position, and a secondary ratchet releasing position, whereat the secondary pawl permits the ratchet to move to its striker release position;
wherein the primary pawl is configured to abut the secondary pawl during a crash condition to prevent the ratchet from moving to its striker release position.

2. The closure latch assembly of claim 1, wherein during a non-crash, normal operating condition of the closure latch assembly, the primary pawl and the secondary pawl are aligned and spaced from one another by a gap while the primary pawl is in the primary ratchet holding position.

3. The closure latch assembly of claim 2, wherein the primary pawl is configured to move under impact with the ratchet to abut the secondary pawl during the crash condition to eliminate the gap.

4. The closure latch assembly of claim 2, wherein the primary pawl is supported by a primary pawl pin and the secondary pawl is supported by a secondary pawl pin, wherein the primary pawl pin is under a reaction load imparted by the ratchet on the primary pawl during a non-crash, normal operating condition of the closure latch assembly while the primary pawl is in its primary ratchet holding positon, and wherein the secondary pawl pin is not under a reaction load imparted by the ratchet on the primary pawl during a non-crash, normal operating condition of the closure latch assembly while the primary pawl is in its primary ratchet holding position.

5. The closure latch assembly of claim 1, wherein primary pawl has a primary holding projection configured to engage a single ratchet notch on the ratchet while in the primary ratchet holding position and the secondary pawl has a secondary holding projection configured to engage the single ratchet notch while in the secondary ratchet holding position.

6. The closure latch assembly of claim 1, further including an auxiliary pawl moveable between a primary pawl blocking position, whereat auxiliary pawl prevents rotation of the primary pawl from its primary ratchet holding position, and a primary pawl releasing position, whereat auxiliary pawl allows the primary pawl to rotate away from the ratchet to its ratchet releasing position.

7. The closure latch assembly of claim 6, further including a release lever, wherein the secondary pawl has a secondary pawl lug and the auxiliary pawl has an auxiliary pawl lug, the release lever being arranged to abut secondary pawl lug to rotate the secondary pawl away from the ratchet, and to abut auxiliary pawl lug to rotate the auxiliary pawl away from its primary pawl blocking position.

8. The closure latch assembly of claim 7, wherein the release lever engages the secondary pawl lug and the auxiliary pawl lug simultaneously.

9. The closure latch assembly of claim 7, wherein the release lever engages the secondary pawl lug first and then the auxiliary pawl lug.

10. The closure latch assembly of claim 7, wherein the primary pawl is supported by a primary pawl pin and the secondary pawl is supported by a secondary pawl pin, the secondary pawl lug and the auxiliary pawl lug extending parallel to the primary pawl pin and the secondary pawl pin.

11. The closure latch assembly of claim 1, wherein the ratchet comprises a single notch for engagement with the primary pawl in the primary striker capture position and with the secondary pawl in the secondary striker capture position.

12. A closure latch assembly for a closure member of a motor vehicle, comprising:
a latch mechanism including a ratchet, a primary pawl, an auxiliary pawl, and a secondary pawl, the ratchet being moveable between a primary striker capture position, a secondary striker capture position, and a striker release position, the primary pawl being moveable between a primary ratchet holding position, whereat the primary pawl holds the ratchet in its primary striker capture position, and a primary ratchet releasing position, whereat the primary pawl permits the ratchet to move to its striker release position;
the auxiliary pawl moveable between a primary pawl blocking position, whereat auxiliary pawl prevents rotation of the primary pawl from its primary ratchet holding position, and a primary pawl releasing position, whereat auxiliary pawl allows the primary pawl to rotate away from the ratchet to its ratchet releasing position under a bias imparted on the primary pawl by a primary pawl biasing member; and
the secondary pawl being moveable between a secondary ratchet holding position, whereat the secondary pawl holds the ratchet in its secondary striker capture position, and a secondary ratchet releasing position, whereat the secondary pawl permits the ratchet to move to its striker release position;
wherein the primary pawl and the secondary pawl are spaced from one another by a gap while the primary pawl is in the primary ratchet holding position.

13. The closure latch assembly of claim 12, wherein the auxiliary pawl is biased by an auxiliary pawl biasing member toward the primary pawl blocking position.

14. The closure latch assembly of claim 13, wherein primary pawl has a primary holding projection configured to engage a single ratchet notch on the ratchet while in the primary ratchet holding position and the secondary pawl has a secondary holding projection configured to engage the single ratchet notch while in the secondary ratchet holding position.

15. The closure latch assembly of claim 14, wherein the primary pawl is supported by a primary pawl pin and the secondary pawl is supported by a secondary pawl pin, wherein the primary pawl pin is under a reaction load imparted by the ratchet on the primary pawl during a non-crash, normal operating condition of the closure latch assembly while the primary pawl is in its primary ratchet holding positon, and wherein the secondary pawl pin is not under a reaction load imparted by the ratchet on the primary pawl during a non-crash, normal operating condition of the closure latch assembly while the primary pawl is in its primary ratchet holding positon.

16. The closure latch assembly of claim 15, wherein the primary pawl is configured to deflect under a bias imparted by the ratchet during a crash condition and abut the secondary pawl to prevent the ratchet from moving to its striker release position.

17. The closure latch assembly of claim 12, further including a release lever, wherein the secondary pawl has a secondary pawl lug and the auxiliary pawl has an auxiliary pawl lug, the release lever being arranged to abut secondary pawl lug to rotate the secondary pawl away from the ratchet, and to abut auxiliary pawl lug to rotate the auxiliary pawl away from its primary pawl blocking position.

18. The closure latch assembly of claim 17, wherein the release lever engages the secondary pawl lug and the auxiliary pawl lug simultaneously.

19. The closure latch assembly of claim 17, wherein the release lever engages the secondary pawl lug first and then the auxiliary pawl lug.

20. The closure latch assembly of claim 17, wherein the release lever is driven by at least one of a power actuated mechanism and a mechanically actuated mechanism.
